(19) United States
(12) Patent Application Publication
(10) Pub. No.: US 2005/0246703 A1
(43) Pub. Date: Nov. 3, 2005

(54) Method and apparatus for programming updates from a network unit to a mobile device

(76) Inventor: Petri Ahonen, Jyvaskyla (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/517,001

(22) PCT Filed: Jun. 11, 2003
(86) PCT No.: PCT/FI03/00462

§ 371 Date: May 31, 2005

(30) Foreign Application Priority Data
Jun. 18, 2002 (FI) 2002/1175

(51) Int. Cl. G06F 9/44

(52) U.S. Cl. 717/172; 717/168

(57) ABSTRACT

The invention relates to transmitting a firmware of a mobile device from a network unit to be accessible for the mobile device and to be programmed in the mobile device. According to the invention, the firmware of a mobile device belonging to a network is updated so that first the update data is transmitted from a unit of the network, in which unit the update data is stored, by means of the mobile device to be stored in an external memory unit of the mobile device. The stored update data is programmed in the permanent memory unit of the mobile device according to the programming logics provided therein.

The invention relates to transmitting the firmware of a mobile device from a network unit to be accessible by the mobile device, and to programming said firmware in the mobile device.

Mobile devices typically include a certain firmware that is always executed when starting the device. The firmware defines for instance the interfaces for the API (application program interface) and for the GUI (graphical user interface). The firmware is responsible for the functional usage environment of the mobile device and for its features. Generally the firmware is programmed in the mobile device already at the factory. Thereafter it can be maintained or updated in service centers. However, for example in certain jobs or in general when the telephone features are developed, outdated or increased, or when errors occur, it is from time to time necessary to update the firmware of a mobile device in order to optimize the operation of the mobile device.

The patent publication EP1087294 introduces a method and apparatus for updating by remote control a firmware recorded in the flash memory of a communication device located in a network. In this solution, the flash memory of the communication device is divided into at least two parts, because the firmware recorded in the flash memory cannot be run and updated simultaneously. In this publication, there also is used the RAM memory of the communication device, into which there is saved data from the running period. The update version of the firmware is transmitted to the communication device and stored in the flash memory thereof in sections, little by little.

The patent publication WO0017749 discloses an automatic firmware updating in a peripheral device. The new firmware version is transmitted from a PC to the peripheral device via USB (universal serial bus). The new version is recorded in the flash memory as separate from the current, active firmware. Prior to installation, the new version is subjected to an integrity check. The updating of the whole firmware is carried out almost automatically, and only a minimal amount of cooperation is required of the user, sometimes none at all.

Also in the patent publication U.S. Pat. No. 6,275,694, the program of a mobile device is updated by remote control. In said publication, the updating is carried out by a remote control terminal that is connected to the data network. In order to update a given portable device, the control terminal establishes a connection with it by sending a certain preparation signal. The portable device receives the signal and checks its validity, and in case the signal is valid, it transmits a verification signal to the control terminal indicating that it is ready to receive the update version of the firmware code. When the control terminal receives the verification signal, it proceeds to download an update version of the firmware code into the flash memory of the mobile device.

In all known arrangements, when updating the firmware of a device, there is utilized the fact that the non-volatile flash memory can be updated in memory unit blocks of a given size, larger than bytes, which blocks can then be removed and reprogrammed irrespective of each other. Even the firmware to be updated is divided into separate units, so that the flash memory can be programmed block by block. Thus, in the case of an interruption in the operation, the data of a given block can be reupdated, so that all of the data stored in the memory is not lost, and neither is the share of the firmware. It is not possible to program the whole flash memory at a time, because it is risky to transmit a large data unit in one block by air, and the memory capacity of the device is not sufficient to store both the old and the new version at the same time.

In typical prior art solutions, there is an external programming device, for instance a PC, that contains the update version and the programming logics, and by means of which the updating process is carried out. These solutions require that the external programming device is capable of performing the programming step, whereafter the update version is transmitted to the device to be updated. In addition, remote downloading requires that the device to be updated has enough memory available. Typically the features of mobile devices, as well as many other portable devices, are small size, limited processing and memory capacity, low power consumption and low price. In addition, these devices are typically specialized in performing certain kinds of functions. These typical features of the devices also cause certain limitations for updating the firmware, when compared with larger, stationary intelligent devices.

The objective of the invention is to realize method and apparatus that is easy, economical and secure in operation for updating firmware.

The objective is achieved by transmitting the update data from a network unit to an external memory unit of the mobile device, from which the mobile device programs and updates its firmware.

The invention is characterized by what is specified in the characterizing parts of the independent claims. Preferred embodiments of the invention are described in the dependent claims.

According to a preferred embodiment of the invention, in order to update the firmware of a mobile device, the update data is downloaded from the network, for instance from a network server, a database or an operator. The update data is stored in an external memory unit of the mobile device, which can be any unit that can be connected to the mobile device and has an own memory capacity, for instance a MultiMediaCard (MMC), or a peripheral device, such as a desktop charger that has memory or that has been provided with memory. According to a preferred embodiment of the invention, the update data stored in the external memory unit of the mobile device is programmed in the firmware unit by means of a programming driver provided in the mobile device.

According to a first preferred embodiment of the invention, the mobile device includes a permanent menu from which the updating of the firmware can be selected. This selection automatically activates certain predetermined loading and programming steps to be carried out. Typically the mobile device automatically contacts a predetermined network server, from where the update data is downloaded to the mobile device. The update data is stored in an external memory unit of the mobile device. Thereafter the firmware of the mobile device can be updated according to the update data stored in the external memory unit.

According to another preferred embodiment of the invention, the updating of the firmware of a mobile device is carried out completely or nearly automatically. The updating can be activated to be performed at a given point of time, as a response to a given function or for mobile devices belonging to a given network or group.

According to a third preferred embodiment of the invention, the updating of the firmware is carried out so that the mobile device browses the update data and different update versions located on the network server. In the browser, there is presented a menu located on the network server, in which menu there can be selected the updating of the firmware of the mobile device. Remote downloading can be carried out by transmitting the update data for instance according to the known WAP (Wireless Application Protocol). When the update data is stored in the external memory unit of the mobile device, the actual updating of the firmware is carried out for instance when the mobile device is next switched on after switching off the power.

In following the invention is explained in more detail with reference to the accompanied drawings, where

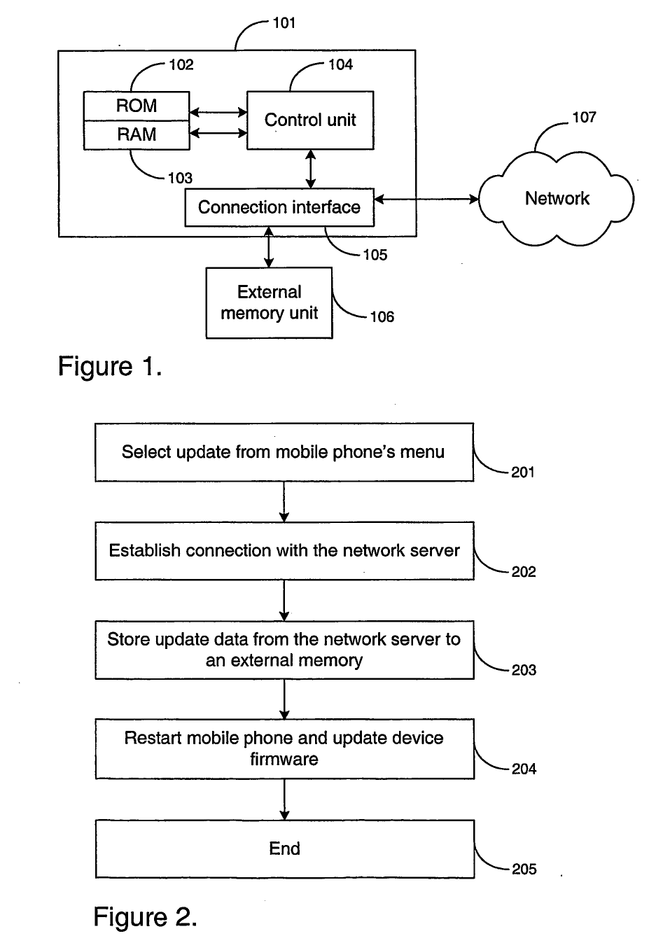

FIG. 1 is a block diagram illustrating an arrangement according to a preferred embodiment of the invention for updating the firmware of a mobile device,

FIG. 2 is a flow diagram illustrating a method according to a preferred embodiment of the invention for updating the firmware of a mobile device,

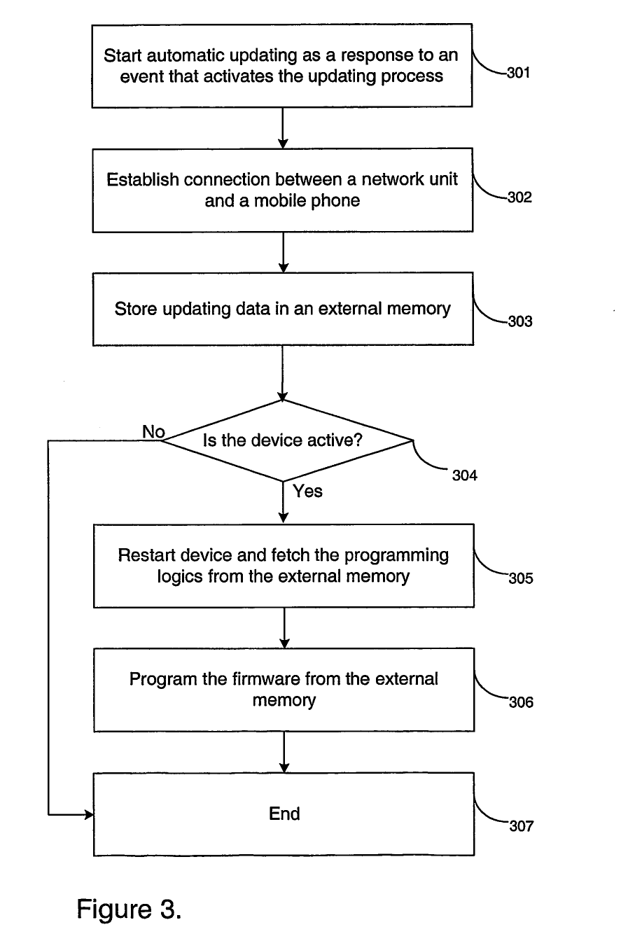

FIG. 3 is a flow diagram illustrating a method according to another preferred embodiment of the invention for updating the firmware of a mobile device, and

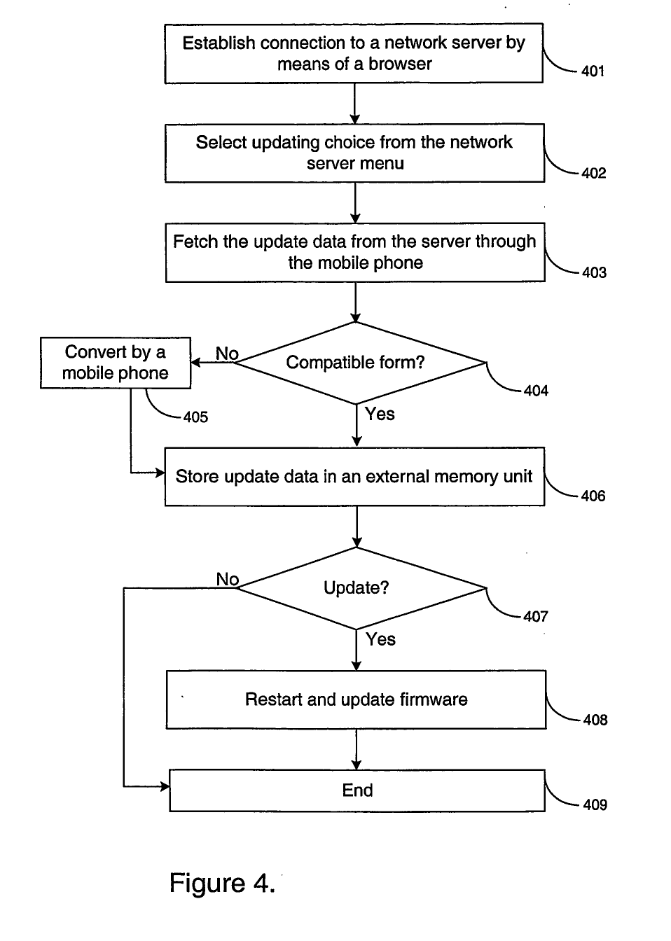

FIG. 4 is a flow diagram illustrating a method according to a third preferred embodiment of the invention for updating the firmware of a mobile device.

FIG. 1 illustrates a mobile device 101 and the required components for updating its firmware according to a preferred embodiment of the invention. The mobile device 101 comprises a control unit 104 that controls all functions of the mobile device. The control unit 104 transmits data between the components and controls the operation of the mobile device units. Among other things, the control unit 104 identifies the protocols to be used, through which data can be transmitted by air.

In this preferred embodiment, the memory unit of the mobile device 101 constitutes the permanent ROM (read-only memory) 102 and the temporary RAM (random access memory) 103. The permanent ROM 102 typically includes a non-volatile flash memory, where the data from the starting block of the device is stored. Typically in the flash memory, there is stored an application by means of which the selected update firmware can be downloaded from the network 107 to an external memory unit 106. In addition, the permanent ROM 102 includes an application or a programming driver by which the updating of the flash memory is carried out on the basis of the update data stored in the external memory unit. According to a preferred embodiment of the invention, in the ROM 102 there is stored a firmware algorithm or -programming driver for running the update version. Typically the firmware algorithm or -programming driver is stored in the RAM 103, at least for the duration of the programming of the update data. According to another preferred embodiment of the invention, the firmware algorithm or -programming driver is stored, along with the update data, to the external memory unit and downloaded therefrom to the RAM 103 prior to programming the update data.

The mobile device includes a connection interface 105, through which the mobile device can be in connection with external components and units. The connection interface 105 is a logic and functional block of the mobile device 101, and it can be realized as a hardware or a software component. According to a preferred embodiment, via the connection interface 105 the mobile device can be in connection with the network 107, for instance with the network servers. Connection with external services, functions and units can be established for instance according to the WAP.

In addition, the connection interface 105 comprises a communication bus through which the external memory unit 106 according to the preferred embodiment of the invention is connected to the mobile device 101. The type and operation of said communication bus, as well as the transmission protocols used by it can vary according to what type of external memory unit 106 is employed. The memory bus can be for instance a digital serial communication bus for connecting a memory card as the external memory unit 106 of the mobile device 101. Typically the external memory unit 106 is closely connected to the mobile device 101. The external memory unit 106 can be any device that has memory or that can be provided with memory. The external memory unit can be for example a so-called I/O device (Input/Output), such as an I/O integrated circuit board, memory card, multimedia card, desktop charger, telephone casing, car accessory, backup disc, game card or a corresponding memory-containing unit to be connected to the device. Memory cards have been developed, among others, by digital camera manufacturers—by way of example, let us mention Sony Standard Memory Stick, Panasonic Secure Digital (SD) memory card or Olympus SmartMedia card. Logically the external memory unit 106 according to the preferred embodiment of the invention is only an external memory unit, and it need not include any functionality.

The network 107 may be any possible communication network to which the mobile device 101 is connected, and which can be contacted through the connection interface 105. The update data to be downloaded from the network 107 can be located on a server of the network 107, in a database, in a device of the operator or in a corresponding storage location of the network. The mobile device 101, or generally a wireless device can, for example by means of the known WAP, gain access to typical Internet services and to other devices and units of the network using the WAP. The connection established from the mobile device 101 to the storage location of the update data can be circuit or packet-switched, message-based or any other type of communication form. Typically the update data is in a binary form, wherefore it can be transmitted by means of any known transmission technique.

FIG. 2 illustrates a method according to a preferred embodiment of the invention for updating the firmware of a mobile device. This method according to a preferred embodiment of the invention is provided with an own permanent menu for updating the firmware. Thus the user may, when he so wishes, update for instance new features or functions in his mobile device. The user typically gets offers of new additional features or functions, for instance through commercial updating versions. In step 201, the updating function is selected in the mobile device's menu. There can be certain different updating alternatives in the menu. In step 202, there is established a connection with the network server. The user does not necessarily have to do anything or even response after he has chosen the update function in the menu of his mobile device. Advantageously there is in advance defined a certain path, address or network location to the permanent updating function to which the connection is made. Thus the update data is always downloaded from a certain authorized party, for instance from a server maintained by the mobile device manufacturer, maintenance site or operator.

When connection to the predetermined network location is established in step 202, the update data is downloaded from the network through the mobile device, to be stored in the external memory unit in step 203. The mobile device may convert the update data to a form required by the external memory unit prior to storing it in the external memory unit. The external memory unit is a unit to be connected to the mobile device, which includes or can be provided with memory. Because the memory capacity of the mobile device is limited, the external memory unit is used for storing the update data. Thus the mobile device is not loaded with the update data that is typically programmed only once. The mobile device must be capable of storing the update data downloaded from the network to the external memory unit and of reading said update data from the external memory unit. Typically the external memory unit only serves as a storage of binary data, and any kind of processing or modifying capacities are not required. Naturally there must be a bus between the mobile device and the external memory unit for transmitting information. Typically the control unit of the mobile device controls the external memory unit connected to the mobile device in similar fashion as other components of the mobile device.

In the embodiment illustrated in FIG. 2, the mobile device is automatically restarted in step 204 after the update data is stored in the external memory unit. When restarting, the update data is programmed in the mobile device from the external memory unit. The programming driver located in the RAM of the mobile device programs the mobile device ROM so that the ROM is emptied, and the new version is programmed from the external memory unit. The programming driver can be stored in the permanent ROM of the mobile device, so that the firmware of the mobile device can always be programmed, even if the rest of the data should be lost.

FIG. 3 illustrates a method according to another preferred embodiment of the invention for automatically updating the firmware of a mobile device. In this embodiment, the starting of the updating function can be triggered by a certain function, or the updating can be performed at given intervals, or the operation can be carried out in a controlled manner at the initiative of the server. These updates can be used for instance for updating all mobile devices in a given local area network, for example the mobile devices of a given group of professionals.

In step 301, there is obtained an indication that the automatic updating of the firmware should be started. Said indication can be for instance the fact that the mobile device is set in a desktop charger after the work time has ended. According to a preferred embodiment, the local area network provider sends, for example by the initiative of the employer, an update command from the server to all or certain devices in the local network. In step 302, there is established a connection between the mobile device to be updated and the network unit containing update data. This is carried out as a so-called background processing, which the user does not necessarily observe. In step 303, the update data is downloaded from the network and stored in the external memory unit of the mobile device. Also these steps are in this embodiment carried out as a background processing, for instance as packet transfer mode.

In step 304 it is checked whether the device to be updated is active. Activity here means that the device is ready for operation and that it can be for instance programmed. In case the device is not active in step 304, the program moves over to step 307 and the operation is ended. The actual updating of the firmware from the external memory unit is performed when the device is started for the next time. In the external memory of a mobile device that is left in the charger for example at the end of a work shift, there can be stored the update data that is downloaded from the network server. When the mobile device is switched on, the downloading is usually started from the internal ROM. If the ROM has been emptied or it contains old version, the update data can be looked up for instance in the external memory unit.

In case the device is active in step 304, it is restarted, and from the external memory unit there is in this embodiment downloaded first the programming driver and the programming logics into the mobile device RAM in step 305. The update data is programmed in the mobile device by means of the programming driver, according to the programming logics, in step 306. When the firmware of the mobile device is updated, the updating operation is ended in step 307.

FIG. 4 illustrates a method according to a third preferred embodiment of the invention for updating the firmware of a mobile device by means of the mobile device browser or by means of another corresponding connection program. The mobile device supplier can for instance detect an error in the firmware of the product and indicate for the user a server where a new, update version can be downloaded in the device without expenses. This is a flexible way to operate from the point of view of both the manufacturer, the maintenance and the user. In step 401, there is established a connection via the mobile device browser to the network server, where the updating versions of programs are stored. The mobile device browser can be for instance a WAP browser, in which case the functions are represented and performed according to the features of said browser. When the connection is established, the mobile device screen shows a server menu which according to a preferred embodiment contains update data or versions for updating the firmware. In step 402, there is selected a desired updating alternative or version in the menu shown by the mobile device browser. There can be provided various different updating alternatives for differently marked terminals, for various different firmwares and different types of user interfaces.

In step 403, the selected update data is downloaded through the mobile device to be stored in the external memory unit. In step 404 it is checked whether the update data is in the form or format required by the external memory unit and the external memory bus. If the form of the update data is compatible with the external memory unit and with the external memory bus, the mobile device controlling the transmission of the update data conducts the update data directly to the external memory bus, and the update data is stored in the external memory unit in step 406. If the transmission and storage form of the update data in step 404 is not compatible with the employed external memory bus and memory unit, the update data is converted in the mobile device, in step 405, into a form required by the external memory unit and by its connection bus prior to transmitting and storing the update data in the external memory unit in step 406. When the update data is stored in the external memory unit, it is possible in step 407 to ask the user whether the update data of the mobile device should be programmed immediately. If the mobile device is not updated immediately, the process is ended in step 409. Now the update data remains in the external memory unit, from which it is advantageously updated when the mobile device is next started.

If the choice in step 407 is to update the firmware immediately, the program moves over to step 408, where the mobile device is restarted, so that the update data of the firmware is read from the external memory unit and programmed in the mobile device. The programming driver can be readily installed in the RAM of the mobile device. According to a preferred embodiment, the programming driver is transmitted to the RAM from the ROM, where it is permanently located. According to another preferred embodiment, the programming driver is downloaded prior to programming the update data from the external memory unit into the mobile device. When the firmware is updated, the operation is ended in step 409.

When mobile device firmwares are updated according to the preferred embodiments of the invention, a given update version to be downloaded from the network can be associated with the requesting mobile device, so that the update version can be programmed in this particular mobile device only. The described mobile device specific transmission of update data is safe, because the party maintaining the update data can control which device receives the certain data and instructions. It is important that the firmware is approved by an official party, so that the functions are tested and desired, and that for instance deliberate errors or viruses are not allowed to spread. According to another preferred embodiment, the update version stored in the external memory unit can be programmed for instance in the mobile devices of a certain group, a local area network or a family, in which case it is not necessary for everybody to carry out the updating process separately. According to a preferred embodiment, for instance the update data that is transferred to an external memory card can freely be programmed even in several mobile devices. The update data stored in the external memory unit can include a counter value that is subtracted by one in connection with each programming process. Thus the counter value defines how many times the update data that was downloaded from the network can still be programmed. When the counter value of the update data is less than one, said update data can be removed from the external memory unit.

The previous specification and the accompanied figures are meant to illustrate the arrangement and the method according to the present invention, and the invention is by no means restricted to the previously described preferred embodiments only. For a man skilled in the art, it is obvious that there are several different alternative methods for applying and realizing the invention, which all fall within the scope of the inventive idea defined in the independent claims.

1. A method for updating a firmware of a mobile device belonging to a network, the method comprising:
transmitting update data from a network unit using a mobile device (403), to which there is connected a logic, external memory unit,
storing the update data in the external memory unit (203, 303, 406) of the mobile device, and
programming the stored update data in a permanent memory unit (204, 306, 408) of the mobile device, according to the programming logics provided in the mobile device.

2. A method according to claim 1, wherein the method comprises a step of transmitting the update data from the network unit to the mobile device as a response to a certain function that triggers the transmission, said function being one of the following: choosing from the network unit's menu (402) by a user, choosing from the mobile device's menu (201) by a user, an appearing of new update data to the network unit, or an outdating (301) of the firmware of the mobile device.

3. A method according to claim 1, wherein the logic, external memory unit is connected to the mobile device by means of an external memory bus (105).

4. A method according to claim 1, wherein the method comprises a step of transmitting the update data by the mobile device (403), where the update data is converted to be compatible with the memory unit and with the memory bus (405) to be connected thereto, whereafter the converted update data is transmitted to the external memory unit along the memory bus (406).

5. A method according to claim 1, wherein the method comprises a step of transmitting the update data by a mobile device, through which the update data is directly transmitted further to the external memory bus of the mobile device along a memory bus (203).

6. A method according to claim 1, wherein the method comprises a step of programming the update data stored in the external memory unit in the mobile device, when the mobile device is switched on for the next time (304, 307, 407, 409).

7. A method according to claim 1, wherein the method comprises a step of copying the programming logics for programming the update data from an external memory unit to the permanent memory unit of the mobile device prior to programming the update data (305).

8. A method according to claim 1, wherein the method comprises a step of storing the programming logics for updating the update data from the permanent memory of the mobile device to the RAM memory of the mobile device prior to programming the update data.

9. An arrangement for updating a firmware of a mobile device belonging to a network, the arrangement including
an external memory unit (106) for storing the update data,
means for transmitting the update data from a network (107) unit to the external memory unit (106) of the mobile device,
means for storing the update data to the external memory unit (106) of the mobile device, and
means for programming the stored update data to a permanent memory unit (102) of the mobile device by means of a programming driver provided in the mobile device.

10. An arrangement according to claim 9, wherein the mobile device includes an external bus (105) for connecting a logic, external memory unit (106) to the mobile device (101).

11. An arrangement according to claim 9, wherein the mobile device includes means for converting the update data into a form (104,105) required by the external memory unit.

12. An arrangement according to claim 9, wherein the mobile device includes means for copying the programming driver to its permanent memory unit (102) from the external memory unit (106) prior to programming the update data.

13. An arrangement according to claim 9, wherein said means are programmable means.

14. A mobile device (101) belonging to a network (107) and including a firmware to be updated, the mobile device comprising:
a connection interface (105) for connecting the mobile device with the network and for transmitting an update data from the network to the mobile device,
a memory bus interface for connecting the mobile device with an external memory unit (106), and for transmitting the update data from the mobile phone to the external memory unit in order to store the update data to the external memory unit, and
means for programming the stored update data to a permanent memory unit of the mobile device according to programming logics provided in the mobile device.

15. A mobile device according to claim 14, wherein the mobile device comprises a mobile phone.

16. An external memory unit, connectable to a mobile device, for storing update data of a firmware of the mobile device, the external memory unit comprising:
a memory bus interface for connecting to the mobile device and for receiving the update data from a network unit through the mobile device,
means for storing the update data, and
means for providing the mobile device with the stored updating data in order to program the stored update data to a permanent memory unit of the mobile device according to programming logics of the mobile device.
